(19) United States
(12) Patent Application Publication
(10) Pub. No.: US 2022/0298360 A1
(43) Pub. Date: Sep. 22, 2022

(54) COATING COMPOSITION CAPABLE OF BEING CURED AND THEN THERMOFORMED, AND PLASTIC PRODUCT USING SAME

(71) Applicant: DONGJIN SEMICHEM CO., LTD., Incheon (KR)

(72) Inventors: Hyun Seok YOO, Seongnam-si (KR); Seung Sock CHOI, Seongnam-si (KR); Kyu Soon SHIN, Seongnam-si (KR); Dong Jin NAM, Seongnam-si (KR); Young Mo KIM, Seongnam-si (KR); Kook Hee LIM, Seongnam-si (KR); Seong Yeon OH, Seongnam-si (KR); HaeRyang LIM, Seongnam-si (KR); Han Bin PARK, Seongnam-si (KR)

(21) Appl. No.: 17/837,177

(22) Filed: Jun. 10, 2022

Related U.S. Application Data
(63) Continuation of application No. PCT/KR2020/018198, filed on Dec. 11, 2020.

(30) Foreign Application Priority Data
Dec. 13, 2019 (KR) 10-2019-0166999

(51) Int. Cl. C09D 4/06; C08F 222/10; C08L 33/12

(52) U.S. Cl. CPC C09D 4/06; C08F 222/1065; C08L 33/12

(57) ABSTRACT

The present invention relates to a coating composition comprising a multifunction acrylate-based oligomer, a thermoplastic polymer, and an organic solvent. The composition can be cured and thermoformed. A coating film made from the composition is capable of being thermoformed and has excellent hardness, durability, and scratch resistance. With the coating film, plastic products, which can be used instead of glass in various industries such as construction, electronic products and automobiles, are provided.

### CROSS-REFERENCE TO RELATED APPLICATIONS

This application is a continuation of International Application No. PCT/KR2020/018198 filed on Dec. 11, 2020, which claims priority to Korean Application No. 10-2019-0166999 filed on Dec. 13, 2019. The applications are incorporated herein by reference.

### TECHNICAL FIELD

The present disclosure relates to a coating composition capable of being cured and then thermoformed and a plastic product using the same. More particularly, the present disclosure relates to a coating composition that enables plastic to replace glass in manufacturing various products in various industries such as construction, electronic products, and automobiles.

### BACKGROUND ART

Recently, efforts have been made to increase the degree of freedom in design in various industrial products such as architecture, electronics, and automobiles. These efforts help improve the convenience of customers and develop high value products with the same performance.

Glass has been used to provide a rigid appearance of many products. Currently, glass is being replaced with plastic for a flexible and moldable appearance. Products are manufactured by thermoforming plastics.

However, as the surface hardness and scratch resistance of plastic are lower than those of glass, various methods to improve the surface hardness and scratch resistance have been proposed. The most commonly performed method among the methods is to apply a coating material on a plastic exterior to improve surface hardness and scratch resistance.

However, conventional coating materials have disadvantages that their structures are changed to three-dimensional network structures after they are cured, thereby losing plasticity against heat, which is an advantage of plastic.

### SUMMARY

Accordingly, an objective of the present disclosure is to provide a coating composition capable of maintaining the molding properties of plastic against heat even after being cured and to provide a coating film and a plastic product that are made by using the composition and are capable of being thermoformed.

Another objective of the present disclosure is to provide a coating composition capable of obtaining a plastic product having excellent hardness, durability, and scratch resistance and a plastic product made by using the composition.

In order to achieve the above objective, the present disclosure provides a coating composition capable of being cured and then thermoformed, including a multifunctional acrylate-based oligomer, a thermoplastic polymer, and an organic solvent.

The present disclosure also provides a thermally moldable coating film formed by curing the coating composition.

The present disclosure also provides a plastic product including (1) a substrate and (2) a coating film that is formed on the substrate and includes (a) a thermoplastic polymer and (b) a multifunctional acrylate-based oligomer that is polymerized to form a three-dimensional network structure.

As the coating composition includes a thermoplastic polymer, a plastic product resulting from the composition can maintain the molding characteristics of plastic against heat, thereby being able to be cured and then thermoformed. As the composition includes a multifunctional acrylate-based oligomer, a plastic product resulting from the composition can have excellent hardness, durability, and scratch resistance.

### BRIEF DESCRIPTION OF DRAWINGS

FIG. 1 shows an actual plastic product produced using the coating composition according to the present disclosure.

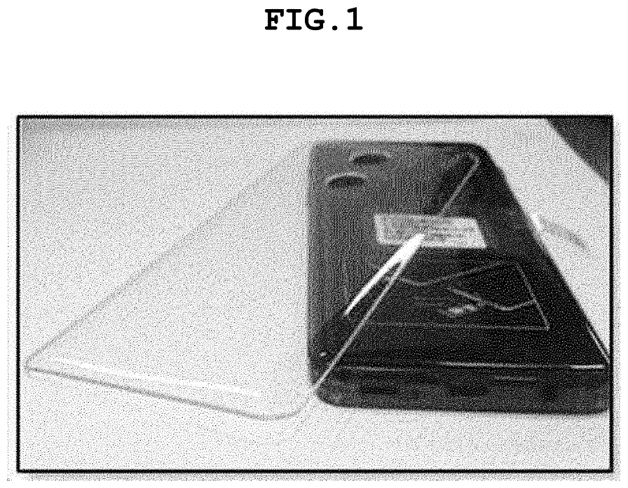

### DETAILED DESCRIPTION

Hereinafter, the present disclosure will be described in more detail.

The coating composition, according to the present disclosure, includes a multifunctional acrylate-based oligomer, a thermoplastic polymer, and an organic solvent.

The multifunctional acrylate-based oligomer of the present disclosure forms a three-dimensional network structure after being cured, thereby improving the hardness, durability, and scratch resistance of the coating film. The term “acrylate-based” is used herein to include both acrylate and methacrylate.

The multifunctional acrylate-based oligomer may be used without limitation in the case of a multifunctional acrylate-based oligomer that may be cured using light or heat, but specifically, the multifunctional acrylate-based oligomer may be at least one selected from the group consisting of a multifunctional urethane acrylate-based oligomer, multifunctional silicone acrylate-based oligomer, a multifunctional epoxy acrylate-based oligomer, a multifunctional polyester acrylate-based oligomer, and a multifunctional melamine acrylate-based oligomer. In particular, it is appropriate to use a multifunctional urethane acrylate-based oligomer in that the hardness, adhesion and flexibility of the coating film can be secured.

The multifunctional acrylate-based oligomer may have 2 to 30 polymerizable functional groups and may be used regardless of the state of a solid or liquid.

The weight-average molecular weight (Mw) of the multifunctional acrylate-based oligomer is 500 to 30,000, specifically 1,000 to 20,000. If the weight-average molecular weight is less than 500, the curing rate is slow and the physical properties may be reduced. If the weight-average molecular weight is greater than 30,000, compatibility may be reduced, and use of initiators, additives, and the like may be restricted.

The content of the multifunctional acrylate-based oligomer is 0.1% to 90% by weight, specifically 10% to 80% by weight, based on 100% by weight of the total coating composition. If the content of the multifunctional acrylate-based oligomer is less than 0.1% by weight, there is a problem in that a smooth network structure cannot be formed after curing, and the physical properties after coating are deteriorated. If the content of the multifunctional acrylate-based oligomer is greater than 90% by weight, it is difficult to control the viscosity, and thus it is difficult to adjust the coating thickness, and uniformity is degraded.

The thermoplastic polymer of the present disclosure serves to impart a thermoplastic effect and is mostly non-chemically blended (mixed) with the three-dimensional network structure formed from the multifunctional acrylate-based oligomer after being cured to impart moldability to the coating film.

The non-chemical mixing means a state in which the chemical reaction is minimized, and the mixture is simply blended. Since the thermoplastic polymer does not substantially include a functional group or a reaction residue that may be cured in a state in which polymerization is completed, the thermoplastic polymer does not participate in the curing reaction of the coating composition. As a result, it is present by simple blending with the three-dimensional network structure formed from the multifunctional acrylate-based oligomer after being cured. That is, the thermoplastic polymer is not deformed by a curing process, and it thus may be the same material before and after being cured. Even if there is deformation, the degree of the deformation is insignificant and does not affect the moldability of the coating film.

The phrase “substantially free of a curable functional group or reactive moiety” means that it does not contain a curable functional group or reactive moiety or contains only some terminal functional groups that may remain after completion of polymerization due to the nature of the polymerization reaction. Since the thermoplastic polymer does not include a curable functional group or a reactive moiety or contains only a terminal end, the thermoplastic polymer may be blended, without forming chemical bonds, even after being cured. Here, the term “without forming chemical bonds” means that no polymers are chemically bound or that more than 90% of the polymers are not chemically bound except for some bonds derived from terminal functional groups.

Since the thermoplastic polymer is blended, without forming chemical bonds, in the three-dimensional network structure formed by polymerization of the multifunctional acrylate-based oligomer after being cured, the coating film made by using the composition may have excellent flexibility and thermoforming properties. The coating film formed by curing the coating composition is thermoformable, which means that the thermoplastic polymer substantially does not contain a curable functional group or reactive moiety, and the thermoplastic polymer is considered to be the same material before and after being cured.

The type of the thermoplastic polymer is not particularly limited, but it may be selected from the group consisting of polymethyl methacrylate (PMMA), polystyrene, polyethylene, polycarbonate, and a combination thereof, for example.

The content of the thermoplastic polymer is 0.1% to 90% by weight, specifically 10% to 70% by weight, based on 100% by weight of the total coating composition. If the content of the thermoplastic polymer is less than 0.1% by weight, the thermoplastic polymer is not sufficiently distributed in the coating composition. If the content is greater than 90% by weight, a three-dimensional network structure is not properly formed after curing, and thus a normal coating film is formed.

The weight-average molecular weight (Mw) of the thermoplastic polymer is 500 to 1,000,000. Specifically, it is advantageous to use a low weight-average molecular weight of 10,000 to 50,000 to achieve excellent molding properties. If the weight-average molecular weight (Mw) is less than 500, the number of terminal reactive groups may increase to increase the chemical bond with the three-dimensional network structure, brittleness may increase after curing. If the weight average molecular weight (Mw) is more than 1,000,000, scratch characteristics may be degraded. That is, when a thermoplastic polymer in an appropriate low molecular weight range is used, scratchability and moldability are excellent.

The multifunctional acrylate-based oligomer and the thermoplastic polymer are blended in a weight ratio of 1:9 to 9:1, specifically 7:3 to 3:7. After curing in the above range, the coating film has thermoforming properties and excellent scratch resistance. If it is out of the above range, molding is not possible due to insufficient flexibility of the coating film after curing, or physical properties such as adhesion and hardness are lowered, which is not appropriate.

The organic solvent of the present disclosure is not particularly limited as long as it is soluble and does not affect the reaction and can be used without particular limitation. Specifically, polar solvents such as lactate-based solvents such as ethyl lactate and normal butyl lactate; ketone-based solvents such as acetone and methyl (isobutyl) ethyl ketone; glycol-based solvents such as ethylene glycol; glycol ether-based solvent such as propylene glycol methyl ether; furan-based solvent such as tetrahydrofuran; dimethylformamide; dimethylacetamide; N-methyl-2-pyrrolidone; or hexane, cyclohexane, cyclohexanone, toluene, xylene, cresol, chloroform, dichlorobenzene, dimethylbenzene, trimethylbenzene, pyridine, methylnaphthalene, nitromethane, acrylonitrile, methylene chloride, octadecylamine, aniline, dimethyl sulfoxide, etc., can be used.

The content of the organic solvent is 0.1% to 95% by weight, specifically 20% to 90% by weight, based on 100% by weight of the total coating composition. If the content of the organic solvent is less than 0.1% by weight, the viscosity of the coating composition increases, and it is difficult to obtain a uniform coating film. If the content of the organic solvent is greater than 90% by weight, it is difficult to control the coating thickness, and the physical properties of the coating film after curing are reduced.

The coating composition of the present disclosure may further include an initiator and an additive, if desired. The initiator generates free radicals by irradiation or heat to induce polymerization through movement of free radicals, and specifically, chloroacetophenone, diethoxyacetophenone, 1-phenyl-2-hydroxy-2-methylpropan-1-one, 1-hydroxycyclohexylphenyl ketone, 2-methyl-1-(4-methylthiophenyl)-2-morpholinopropan-1-one, 2,4,6-trimethyl benzoyl diphenylphosphine oxide, camphor quinone, 2,2′-azobis(2-methylbutyronitrile), dimethyl-2,2′-azobis(2-methyl butyrate), 3,3-dimethyl-4-methoxy-benzophenone, p-methoxybenzophenone, 2,2-diethoxy acetophenone, 2,2-dimethoxy-1,2-diphenylethan-1-one, t-butylperoxy maleic acid, t-butyl hydroperoxide, 2,4-dichlorobenzoyl peroxide, 1,1-di(t-butylperoxy)-3,3,5-trimethylcyclohexane, N-butyl-4,4′-di(t-butylperoxy)valerate, and a mixture thereof may be used. The initiator may be included in an amount of 0.01 to 10 parts by weight, specifically 0.5 to 7 parts by weight, based on 100 parts by weight of the total coating composition.

The coating composition may include one or more additives generally used. Examples of the additives may include BYK's BYK-307, BYJ-320, BYK-331, BYK-333, BYK-378, BYK-3500, BYK-350, BYK-361N, BYK-388, BYK-399, BYK-055, BYK-063, BYK-071, BYK-085, BYK-390, BYK-014, BYK-020; EVONIK's TEGO Glide 410, TEGO Glide 411, TEGO Glide 415, TEGO Glide 420, TEGO Glide 432, TEGO Glide 440, TEGO Glide 450, TEGO RAD 2100, TEGO RAD 2200N, TEGO RAD 2300; 3M′s FC-4430, FC-4432, FC-4434, etc. The additive may be included in an amount of 0.01 to 10 parts by weight, specifically 0.1 to 5 parts by weight, based on 100 parts by weight of the total coating composition.

According to another embodiment, the present disclosure provides a coating film that can be thermoformed. The thermoformable coating film may be formed by curing the coating composition of the present disclosure. The multifunctional acrylate-based oligomer is polymerized to form a three-dimensional network. Thermoplastic polymers are blended, without forming chemical bonds” in the three-dimensional network structure.

The thermoplastic polymer does not contain a curable functional group or reactive moiety substantially. Since the thermoplastic polymer does not contain a curable functional group or reactive moiety or contains only the terminal thereof, the thermoplastic polymer may be blended, without forming chemical bonds, with the three-dimensional network structure. Due to the structure, a coating film resulting from the coating composition is capable of being cured and then thermoformed. Here, the term “without forming chemical bonds” means that no polymers are chemically bound or that more than 90% of the polymers are not chemically bound except for some bonds derived from terminal functional groups.

The thermoplastic polymer is not deformed by curing and thus may be the same material before and after curing. Even if there is deformation, the degree of the deformation is insignificant and does not affect the moldability of the coating film. Therefore, the coating film formed by curing the coating composition containing the thermoplastic polymer can be thermoformed, and a plastic product including the thermoformable coating film can be obtained.

The thermoplastic polymers are simply blended, without forming chemical bonds, in the three-dimensional network structure formed by polymerization of the multifunctional acrylate-based oligomer. As a result, even after curing, due to the thermal behavior of the thermoplastic polymer, the glass transition temperature (Tg) that is difficult to be seen in the coated coating film with the conventional three-dimensional network structure may be exhibited. The glass transition temperature (Tg) of the coating film in accordance with the present invention may be 80° C. to 170° C., specifically 110° C. to 160° C. If the glass transition temperature (Tg) is out of the range, utilization may be limited due to the limitation of the molding temperature of the substrate on which the coating film is formed. [42] The coating film may have a thickness of 1 to 100 um after curing, specifically 3 to 50 um, and more specifically, 10 um. If the thickness of the coating film is less than 1 um, the formed coating film does not implement desired properties. If the thickness of the coating film is greater than 100 um, problems such as cracks during molding may occur.

According to another embodiment, the present disclosure provides a plastic product including a thermoformable coating film. Specifically, the plastic product includes (1) a substrate and (2) a coating film that is formed on the substrate and includes (a) a thermoplastic polymer and (b) a multifunctional acrylate-based oligomer polymerized to form a three-dimensional network structure.

The substrate can be used without limitation as long as it is a known substrate. For example, polycarbonate (PC), polymethylmethacrylate (PMMA), polyethylene terephthalate (PET), polyimide (PI), or a combination thereof may be used. The substrate may include, for example, a single substrate or a composite substrate.

Since the thermoplastic polymer does not substantially include a functional group or a reaction residue that may be cured in a state in which polymerization is completed, the thermoplastic polymer does not participate in the curing reaction of the coating composition for the production of a coating film. The thermoplastic polymer is simply blended with the three-dimensional network structure formed from the multifunctional acrylate-based oligomer after curing. That is, the thermoplastic polymer is not deformed by curing and thus may be the same material before and after curing. Even if there is deformation, the degree of the deformation is insignificant and does not affect the moldability of the coating film.

The phrase “substantially free of a curable functional group or reactive moiety” means that it does not contain a curable functional group or reactive moiety or contains only some terminal functional groups that may remain after completion of polymerization due to the nature of the polymerization reaction. Since the thermoplastic polymer does not include a curable functional group or a reactive moiety or contains only a terminal end, the thermoplastic polymer may be blended without forming chemical bonds even after being cured. Here, the term “without forming chemical bonds” means that no polymers are chemically bound or that more than 90% of the polymers are not chemically bound except for some bonds derived from terminal functional groups.

In addition, since the thermoplastic polymer is blended without forming chemical bonds in the three-dimensional network structure formed by polymerization of the multifunctional acrylate-based oligomer after curing, the flexibility and thermoforming properties of the coating film may be increased. The coating film formed by curing the coating composition is thermoformable, which means that the thermoplastic polymer substantially does not contain a curable functional group or reactive moiety. The thermoplastic polymer is considered to be the same material before and after curing.

The glass transition temperature (Tg) of the coating film may be 80° C. to 170° C., specifically 110° C. to 160° C. If the glass transition temperature (Tg) is out of the range, utilization may be limited due to the limitation of the molding temperature of the substrate on which the coating film is formed.

The plastic product includes a three-dimensional network structure to ensure surface hardness and scratch resistance. Due to the characteristics of the thermoplastic polymer blended, without forming chemical bonds, with the three-dimensional network structure, it is possible to maintain the molding properties of plastics by heat, allowing free molding and further re-molding.

In addition, the plastic product in accordance with the present invention may have greater flexural strength than conventional plastic products. The plastic product may be formed in a curved shape and may have high hardness, high durability, and high scratch resistance.

Therefore, since the plastic product of the present disclosure has a rigid surface like glass, and it maintains free molding characteristics, it can be applied to a glass replacement cover and protective cover for the front or rear of a mobile phone, automobile interior materials, the front or rear protective film of the furniture and home appliances, protective goggles, etc., and it can be used in various applications to replace glass in order to increase the freedom of design.

The present disclosure may further include a method for manufacturing a plastic product including a thermoformable coating film. The manufacturing method of the plastic product includes: applying a coating composition that includes a multifunctional acrylate-based oligomer, a thermoplastic polymer, and an organic solvent to a substrate; drying the coated composition to remove a solvent and curing it to form a coating film; and manufacturing a plastic product by thermoforming the substrate on which the coating film is formed.

The coating composition may be cured by heating or exposure to light such as UV. When the coating composition is cured, a thermoplastic polymer is not chemically bound to a three-dimensional network structure formed by polymerizing a multifunctional acrylate-based oligomer but simply blended with the three-dimensional network structure. A coating film resulting from the composition is capable of being cured and then thermoformed, and a plastic product with the coating film may be formed in a desired shape.

### EXAMPLES

Hereinafter, the present disclosure will be described in more detail through Examples, but the present disclosure is not limited by the Examples.

[Evaluation Method]

Glass transition temperature (Tg) measurement: It was measured using a Differential Scanning Calorimeter (DSC). After adding 6 mg of the sample to the DSC measurement pan, the sample was loaded into DSC, and the temperature was raised from 25° C. to 250° C. at a rate of 10° C. per minute to obtain a thermal analysis graph. Tg was measured by observing the change in the slope of this graph.

Pencil hardness: According to JIS 5600-5-4, it was evaluated with a load of 1000 g. A pencil made by Mitsubishi was used, and it was determined to be defective if two or more scratches occurred by performing 5 times per hardness of one pencil.

Adhesion evaluation: According to JIS K5600-5-6, 100 scratches with a grid pattern were made with a cutter blade at 1 mm intervals, and the adhesive tape was attached to it and removed in a 90° direction to visually check whether the surface of the coating film adhered to the adhesive tape and fell. The notation was indicated as the number that did not fall out of 100 (e.g.,: The number that does not fall/100 is expressed, and the number that does not fall by 100 is expressed as 100/100).

Friction resistance evaluation: According to JIS 5600-5-4, it was evaluated with a load of 1000 g. The number of scratches was confirmed using steel wool.

Fingerprint evaluation: Contact angles of distilled water before and after coating was measured using a contact angle measuring device. KRUSS' DSA100 equipment was used for the contact angle measuring device, and after 3 ml of deionized water was dropped on the coating surface, the left and right inner angles of the formed water droplets were measured and calculated as the average value.

Thermoforming evaluation: The molding process was performed using heat and pressure in a mold manufactured for molding. After thermoforming, whether it was a good product or defective product was determined on the basis of the occurrence of cracks in the coating film. It was determined to be a good product if a crack did not occur in the coating film. At this time, the mold and the molding temperature may be appropriately adjusted according to the sample to be molded.

### Preparation Example 1

### Preparation of Coating Composition

5 g of a multifunctional acrylate-based oligomer (6-functional urethane acrylate oligomer, Miwon Corporation) and 5 g of a thermoplastic polymer (PMMA, MW 16,000) were blended with 10 g of propylene glycol methyl ether to prepare 20 g of a coating composition. Then, based on 100 parts by weight of the prepared coating composition, 3 parts by weight of Irgacure 184 (BASF) as an initiator and 1 part by weight of BYK-333 (BYK) as a slipping additive were added to prepare a final coating composition.

### Preparation Example 2

### Preparation of Coating Composition

A coating composition was prepared in the same manner as in Preparation Example 1, except that 6 g of a multifunctional acrylate-based oligomer (6-functional urethane acrylate oligomer, Miwon Corporation) and 4 g of a thermoplastic polymer (PMMA) were used.

### Preparation Example 3

### Preparation of Coating Composition

A coating composition was prepared in the same manner as in Preparation Example 1, except that 7 g of a multifunctional acrylate-based oligomer (6-functional urethane acrylate oligomer, Miwon Corporation) and 3 g of a thermoplastic polymer (PMMA) were used.

### Preparation Example 4

### Preparation of Coating Composition

A coating composition was prepared in the same manner as in Preparation Example 1, except that 8 g of a multifunctional acrylate-based oligomer (6-functional urethane acrylate oligomer, Miwon Corporation) and 2 g of a thermoplastic polymer (PMMA) were used.

### Preparation Example 5

### Preparation of Coating Composition

A coating composition was prepared in the same manner as in Preparation Example 1, except that 9 g of a multifunctional acrylate-based oligomer (6-functional urethane acrylate oligomer, Miwon Corporation) and 1 g of a thermoplastic polymer (PMMA) were used.

### Preparation Example 6

### Preparation of Coating Composition

A coating composition was prepared in the same manner as in Preparation Example 1, except that 4 g of a multifunctional acrylate-based oligomer (6-functional urethane acrylate oligomer, Miwon Corporation) and 6 g of a thermoplastic polymer (PMMA) were used.

### Preparation Example 7

### Preparation of Coating Composition

A coating composition was prepared in the same manner as in Preparation Example 1, except that 3 g of a multifunctional acrylate-based oligomer (6-functional urethane acrylate oligomer, Miwon Corporation) and 7 g of a thermoplastic polymer (PMMA) were used.

### Preparation Example 8

### Preparation of Coating Composition

A coating composition was prepared in the same manner as in Preparation Example 1, except that 2 g of a multifunctional acrylate-based oligomer (6-functional urethane acrylate oligomer, Miwon Corporation) and 8 g of a thermoplastic polymer (PMMA) were used.

### Preparation Example 9

### Preparation of Coating Composition

A coating composition was prepared in the same manner as in Preparation Example 1, except that 1 g of a multifunctional acrylate-based oligomer (6-functional urethane acrylate oligomer, Miwon Corporation) and 9 g of a thermoplastic polymer (PMMA) were used.

### Preparation Example 10

### Preparation of Coating Composition

A coating composition was prepared in the same manner as in Preparation Example 1, except that 5 g of a multifunctional acrylate-based oligomer (6-functional silicone acrylate oligomer, KELLON) and 5 g of a thermoplastic polymer (PMMA) were used.

### Comparative Preparation Example 1

### Preparation of Coating Composition

A coating composition was prepared in the same manner as in Preparation Example 1, except that 9.5 g of a multifunctional acrylate-based oligomer (6-functional urethane acrylate oligomer, Miwon Corporation) and 0.5 g of a thermoplastic polymer (PMMA) were used.

### Comparative Preparation Example 2

### Preparation of Coating Composition

A coating composition was prepared in the same manner as in Preparation Example 1, except that 0.5 g of a multifunctional acrylate-based oligomer (6-functional urethane acrylate oligomer, Miwon Corporation) and 9.5 g of a thermoplastic polymer (PMMA) were used.

### Comparative Preparation Example 3

### Preparation of Coating Composition

A coating composition was prepared in the same manner as in Preparation Example 1, except that 10 g of a multifunctional acrylate-based oligomer (6-functional urethane acrylate oligomer, Miwon Corporation) and a thermoplastic polymer were not used.

### Example 1

### Manufacturing of Plastic Products

The coating composition prepared in Preparation Example 1 was applied to a PC/PMMA substrate with a thickness of 10 μm. It was applied by a slit coating method, and then, after heat treatment at 85° C. in hot air conditions for 10 minutes, UV curing was performed using a UV lamp at 1000 mJ/cm² conditions to prepare a coating film. The physical properties of the prepared coating film were measured by the evaluation method described above. Thereafter, the thermoforming evaluation was performed by manufacturing a plastic product by thermoforming at 140° C. and 0.2 kgf pressure, and the evaluation results are shown in Table 1 below.

### Examples 2 to 10

### Manufacturing of Plastic Products

Examples 2 to 10 were prepared in the same manner as in Example 1, except that the coating compositions prepared in Preparation Examples 2 to 10 were used. The physical properties of the prepared plastic products were measured in the same manner as in Example 1, and the results are shown in Table 1 below. However, in the case of thermoforming evaluation, it was appropriately adjusted according to the samples of each Example at a temperature of 160° C. or less and a pressure of 1 kgf or less.

### Comparative Examples 1 to 3

### Manufacturing of Plastic Products

It was prepared in the same manner as in Example 1, except that the coating compositions prepared in Comparative Preparation Examples 1 to 3 were used, and the results of measuring the physical properties of the prepared cured coating film and plastic product are shown in Table 1 below. However, in the case of thermoforming evaluation, it was appropriately adjusted according to the samples of each Example at a temperature of 160° C. or less and a pressure of 1 kgf or less.

TABLE 1

| | | | Adhesion | | | | Thermo | |
|---|---|---|---|---|---|---|---|---|
| | | | (Number of | | Friction | Contact | forming | |
| | Oligomer | Polymer | non-falling/ | | resistance | angle | (Number of | Tg |
| | (g) | (g) | total) | Hardness | (number) | (°) | Goods/Total) | (° C.) |
| <Example 1> | 5. | 5. | 100/100 | 3H | 500. | 110. | 5/5 | 137 |
| <Example 2> | 6. | 4. | 100/100 | 3H | 700 | 110 | 5/5 | 140 |
| <Example 3> | 7. | 3. | 100/100 | 3H | 800 | 110 | 4/5 | 146 |
| <Example 4> | 8 | 2 | 100/100 | 3H | 800 | 110 | 3/5 | 152 |
| <Example 5> | 9 | 1 | 100/100 | 3H | 900 | 110 | 3/5 | 156 |
| <Example 6> | 4 | 6 | 100/100 | 3H | 400 | 110 | 4/5 | 135 |
| <Example 7> | 3 | 7 | 100/100 | 3H | 200 | 110 | 4/5 | 134 |
| <Example 8> | 2 | 8 | 100/100 | 2H | 100 | 110 | 5/5 | 131 |
| <Example 9> | 1 | 9 | 100/100 | 2H | 50 | 110 | 5/5 | 130 |
| <Example 10> | 5 | 5 | 100/100 | 2H | 500 | 110 | 4/5 | 141 |
| <Comparative | 9.5 | 0.5 | 100/100 | 3H | 1000 | 110 | 1/5 | Invisible |
| Example 1> | | | | | | | | |
| <Comparative | 0.5 | 9.5 | 50/100 | HB | 0 | 110 | Unable to | 130 |
| Example 2> | | | | | | | evaluate | |
| <Comparative | 10 | 0 | 100/100 | 3H | 1000 | 110 | 0/5 | Invisible |
| Example 3> | | | | | | | | |

Referring to Table 1, Examples 1 to 10 have excellent friction resistance evaluation results. Since the glass transition temperature (Tg) has a value of 110° C. to 160° C., it may be seen that friction resistance is exhibited and thermal formability is excellent. As in Comparative Examples 1 to 3, when the mixing ratio of the multifunctional acrylate-based oligomer and the thermoplastic polymer is out of the range of the present disclosure, the coating film forms a hard three-dimensional network structure, and the hardness and scratch resistance properties are excellent, but it may be seen that thermal molding is not possible due to insufficient flexibility without showing the Tg value (Comparative Examples 1 and 3), adhesion and hardness are degraded, and thermal molding is not possible due to a decrease in adhesion (Comparative Example 2).

1. A coating composition capable of being cured and then thermoformed, the coating composition comprising:
a multifunctional acrylate-based oligomer;
a thermoplastic polymer; and
an organic solvent.

2. The coating composition of claim 1, wherein the multifunctional acrylate-based oligomer is at least one selected from the group consisting of a multifunctional urethane acrylate-based oligomer, a multifunctional silicone acrylate-based oligomer, a multifunctional epoxy acrylate-based oligomer, a multifunctional polyester acrylate-based oligomer, and a multifunctional melamine acrylate-based oligomer.

3. The coating composition of claim 1, wherein the thermoplastic polymer is selected from the group consisting of polymethylmethacrylate, polystyrene, polyethylene, polycarbonate, and a combination thereof.

4. The coating composition of claim 1, wherein the thermoplastic polymer is substantially free of a curable functional group or reactive moiety.

5. The coating composition of claim 1, wherein the content of the multifunctional acrylate-based oligomer is 0.1% to 90% by weight based on 100% by weight of the total coating composition, the content of the thermoplastic polymer is 0.1% to 90% by weight based on 100% by weight of the total coating composition, and the content of the organic solvent is 0.1% to 95% by weight based on 100% by weight of the total coating composition.

6. The coating composition of claim 1, wherein the multifunctional acrylate-based oligomer and the thermoplastic polymer are blended in a weight ratio of 1:9 to 9:1.

7. The coating composition of claim 1, wherein the coating composition further comprises 0.01 to 10 parts by weight of an initiator based on 100 parts by weight of the total coating composition.

8. A thermoformable coating film formed by curing the coating composition of claim 1.

9. The coating film of claim 8, wherein the glass transition temperature of the coating film is 80° C. to 170° C.

10. The coating film of claim 8, wherein the thermoplastic polymer is blended, without forming chemical bonds, in a three-dimensional network structure formed by polymerization of a multifunctional acrylate-based oligomer.

11. A plastic product comprising:
a substrate; and
a coating film that is formed on the substrate,
wherein the coating film comprises (1) a multifunctional acrylate-based oligomer polymerized to form a three-dimensional network structure and (2) a thermoplastic polymer.

12. The plastic product of claim 11, wherein the thermoplastic polymer is substantially free of a curable functional group or reactive moiety.

13. The plastic product of claim 11, wherein the thermoplastic polymer is blended, without forming chemical bonds, in a three-dimensional network structure formed by polymerization of a multifunctional acrylate-based oligomer.

14. The plastic product of claim 11, wherein the substrate is selected from the group consisting of polycarbonate, polymethyl methacrylate, polyethylene terephthalate, polyimide, and a combination thereof.

15. The plastic product of claim 11, wherein the glass transition temperature of the coating film is 80° C. to 170° C.
